(19) United States
(12) Patent Application Publication
(10) Pub. No.: US 2026/0368542 A1
(43) Pub. Date: Nov. 19, 2026

(54) SYSTEM FOR NOON DETECTION AND AUTOMATIC INTERPRETATION OF DETECTED LOGS BASED ON MACHINE LEARNING

(71) Applicant: CheckMAL Inc., Gyeonggi-do (KR)

(72) Inventors: Hwan Gui CHOI, Gyeonggi-do (KR); Hyo Jun KIM, Gyeonggi-do (KR)

(73) Assignee: CheckMAL Inc., Gyeonggi-do (KR)

(21) Appl. No.: 19/674,749

(22) Filed: May 12, 2026

(30) Foreign Application Priority Data
May 15, 2025 (KR) 10 2025 0063432

(51) Int. Cl. G06N 3/092; G06N 3/0475

(52) U.S. Cl. CPC G06N 3/092; G06N 3/0475

(57) ABSTRACT

This specification relates to a method for a system to perform true/false positive determination and automatic interpretation of a log, the method including: collecting the log related to a security event through a log collection module; preprocessing the log through a preprocessing module and constructing a behavior graph based on the preprocessed log; classifying the true/false positives of the log based on the log and the behavior graph through a machine learning module; and generating a corresponding message based on the classification of the true/false positives through a Large Language Model (LLM) module.

### BACKGROUND

This specification relates to the field of artificial intelligence (AI) and information security technology, and more specifically, to a system that automatically determines true positives and false positives of items detected in security logs and interprets and presents the grounds using machine learning technology based on inverse reinforcement learning (IRL) and supervised learning (SL) and a large language model (LLM).

In the information security environment, detection technologies for malicious programs such as ransomware have continuously evolved, and various security solutions detect suspicious logs based on file execution paths, hash values, and behavior-based analysis. However, such detection systems generate a significant number of false positives in addition to true positives, and cases where legitimate programs are incorrectly detected as malicious are frequent. As a result, the final determination is often performed manually.

Previously, the general procedure involved that users check detection logs, inquire about the true/false positive status with the security solution provider's customer support or analysis team, and then have the analysis team manually determine the status based on internal standards before proposing a response. Since this process requires humans to directly interpret and judge logs, it consumes significant time and manpower resources, and there were limitations in terms of response speed and accuracy.

In particular, in enterprise environments, thousands of security logs are generated daily, and manually determining and responding to all of them is highly inefficient. Therefore, there is an increasing need for technology that enables to automate the log analysis and true/false positive determination processes, and provide the basis for such judgments in an understandable format.

### SUMMARY

This specification is to implement a machine learning-based classification technology enabling to automatically classify whether there are true/false positives based on log data and to perform learning for the judgment criteria for such classification.

In addition, this specification proposes a method that is to reduce resources required for security log analysis through an automated interpretation and response system.

The technical aspects to be achieved by this specification are not limited to the technical aspects mentioned above, and other technical aspects not mentioned will be clearly understood by those skilled in the art to which this specification pertains from the detailed description of the specification below.

As an aspect of this specification, a method for a system to perform true/false positive determination and automatic interpretation of a log may include: collecting the log related to a security event through a log collection module; preprocessing the log through a preprocessing module and constructing a behavior graph based on the preprocessed log; classifying the true/false positives of the log based on the log and the behavior graph through a machine learning module; and generating a corresponding message based on the classification of the true/false positives through a Large Language Model (LLM) module.

In addition, the log may include a system event log collected from a terminal, a server, or network equipment.

In addition, the preprocessing module may extract, based on the log, a feature related to file extension, a path, an execution time, whether auto-run is registered, or the number of accessed files.

In addition, the behavior graph may be composed in a node-edge structure based on the causal relationship and chronological order between events, based on the log.

In addition, the machine learning module may learn a true/false positive classification model using pre-labeled log data based on a supervised learning algorithm.

In addition, the machine learning module may include an inverse reinforcement learning algorithm, estimates a reward function based on the past judgment history of a security expert, and models a policy based on the said reward function.

As another aspect of this specification, a system for performing true/false positive determination and automatic interpretation of a log may include: a log collection module that collects the log related to a security event; a preprocessing module that preprocesses the log and constructs a behavior graph based on the preprocessed log; a machine learning module that classifies the true/false positives of the log based on the log and the behavior graph; and a Large Language Model (LLM) module that generates a corresponding message based on the classification of the true/false positives.

According to embodiments of this specification, a machine learning-based classification technology can be implemented to automatically classify whether there are true/false positives based on log data and to perform learning for the judgment criteria for such classification.

In addition, according to embodiments of this specification, resources required for security log analysis can be reduced through an automated interpretation and response system.

The effects obtainable from this specification are not limited to the effects mentioned above, and other effects not mentioned will be clearly understood by those skilled in the art to which this specification pertains from the description below.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device related to this specification;

FIG. 2 is a block diagram of an AI device according to an embodiment of this specification;

FIG. 3 illustrates a system for determining true/false positives and automatically interpreting a detected log based on machine learning to which this specification is applicable;

FIG. 4 illustrates a method for determining true/false positives and automatically interpreting a log to which this specification is applicable; and

FIG. 5 illustrates a behavior graph to which this specification is applicable.

### DETAILED DESCRIPTION

Hereinafter, embodiments disclosed in this specification will be described in detail with reference to the accompanying drawings, wherein identical or similar components are assigned the same reference numerals regardless of drawing symbols, and redundant descriptions thereof will be omitted. The suffixes "module" and "unit" for components used in the following description are given or used interchangeably only for ease of specification drafting, and do not have meanings or roles that are distinct from each other per se. In addition, in describing the embodiments disclosed in this specification, when it is determined that a detailed description of related known technology may obscure the gist of the embodiments disclosed in this specification, the detailed description thereof will be omitted. In addition, the accompanying drawings are only for facilitating easy understanding of the embodiments disclosed in this specification, and the technical ideas disclosed in this specification are not limited by the accompanying drawings, and it should be understood to include all changes, equivalents, and substitutes included in the spirit and technical scope of this specification.

Terms including ordinal numbers such as first, second, etc. may be used to describe various components, but the components are not limited by the terms. The terms are used only for distinguishing one component from another component.

When a component is referred to as being "connected" or "coupled" to another component, it should be understood that it may be directly connected or coupled to the other component, while other components may also exist in between. On the other hand, when a component is referred to as being "directly connected" or "directly coupled" to another component, it should be understood that no other components exist in between.

The singular expression includes the plural expression, unless the context clearly indicates otherwise.

In this application, terms such as "include" or "have" are intended to designate that the features, numbers, steps, operations, components, parts, or combinations thereof described in the specification are present, and should be understood as not precluding in advance the presence or possibility of addition of one or more other features, numbers, steps, operations, components, parts, or combinations thereof.

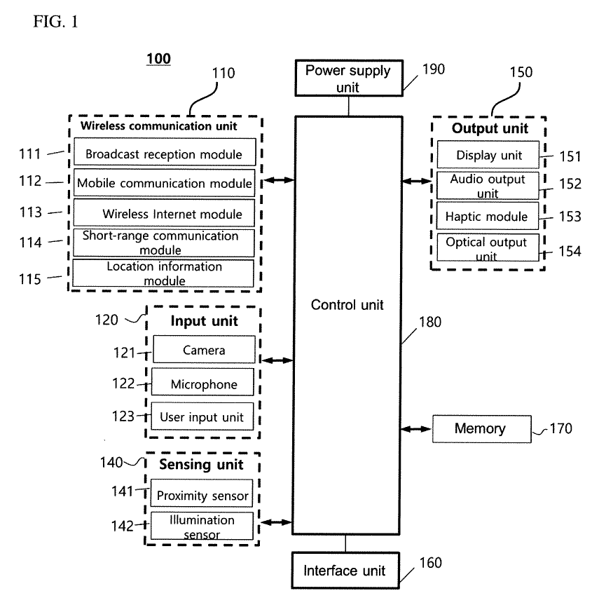

FIG. 1 is a block diagram illustrating an electronic device related to this specification.

The electronic device 100 may include a wireless communication unit 110, an input unit 120, a sensing unit 140, an output unit 150, an interface unit 160, a memory 170, a control unit 180, and a power supply unit 190. The components illustrated in FIG. 1 are not essential for implementing the electronic device, and thus the electronic device described herein may include more or fewer components than those listed above.

More specifically, among the components, the wireless communication unit 110 may include one or more modules that enable wireless communication between the electronic device 100 and a wireless communication system, between the electronic device 100 and another electronic device 100, or between the electronic device 100 and an external server. Furthermore, the wireless communication unit 110 may include one or more modules that connect the electronic device 100 to one or more networks.

The wireless communication unit 110 may include at least one of a broadcast reception module 111, a mobile communication module 112, a wireless Internet module 113, a short-range communication module 114, and a location information module 115.

The input unit 120 may include a camera 121 or video input unit for video signal input, a microphone 122 or audio input unit for audio signal input, and a user input unit (123, e.g., a touch key, a mechanical key, etc.) for receiving information from the user. Voice data or image data collected by the input unit 120 may be analyzed and processed into user control commands.

The sensing unit 140 may include one or more sensors for sensing at least one of information within the electronic device, information about the surrounding environment surrounding the electronic device, and user information. For example, the sensing unit 140 may include at least one of a proximity sensor 141, an illumination sensor 142, a touch sensor, an acceleration sensor, a magnetic sensor, a gravity sensor (G-sensor), a gyroscope sensor, a motion sensor, an RGB sensor, an infrared sensor (IR sensor), a fingerprint recognition sensor, an ultrasonic sensor, an optical sensor (e.g., a camera (see 121)), a microphone (see 122), a battery gauge, an environmental sensor (e.g., a barometer, a hygrometer, a thermometer, a radiation detection sensor, a heat detection sensor, a gas detection sensor, etc.), or a chemical sensor (e.g., an electronic nose, a healthcare sensor, a biometric sensor, etc.). Meanwhile, the electronic device disclosed herein may utilize information sensed by at least two or more of these sensors in combination.

The output unit 150 is to generate output related to visual, auditory, or tactile sensations and may include at least one of a display unit 151, an audio output unit 152, a haptic module 153, and an optical output unit 154. The display unit 151 may be formed as a touch screen by forming a layered structure with a touch sensor or forming an integrated structure. This touch screen functions as a user input unit 123 that provides an input interface between the electronic device 100 and the user, while also providing an output interface between the electronic device 100 and the user.

The interface unit 160 serves as a path for various types of external devices connected to the electronic device 100. The interface unit 160 may include at least one of a wired/wireless headset port, an external charger port, a wired/wireless data port, a memory card port, a port for connecting a device equipped with an identification module, an audio input/output (I/O) port, a video input/output (I/O) port, and an earphone port. The electronic device 100 may perform appropriate control related to the connected external device in response to the external device being connected to the interface unit 160.

Furthermore, the memory 170 stores data supporting various functions of the electronic device 100. The memory 170 may store data and instructions for the operation of the electronic device 100, and a number of application programs (or applications) running on the electronic device 100. At least some of these application programs may be downloaded from an external server through wireless communication. Additionally, at least some of these applications may be present on the electronic device 100 from the time of shipment for the basic functions of the electronic device 100 (e.g., incoming and outgoing calls, message reception and transmission). Meanwhile, the application programs are stored in the memory 170, installed on the electronic device 100, and driven by the control unit 180 to perform the operations (or functions) of the electronic device.

In addition to the operations related to the application programs, the control unit 180 typically controls the overall operation of the electronic device 100. The control unit 180 processes signals, data, and information input or output through the components described above, or runs application programs stored in the memory 170, thereby providing or processing appropriate information or functions to the user.

Furthermore, the control unit 180 may control at least some of the components described with reference to FIG. 1 to run the application programs stored in the memory 170. Furthermore, the control unit 180 may operate at least two or more of the components included in the electronic device 100 in combination to run the application programs.

The power supply unit 190, under the control of the control unit 180, receives external or internal power and supplies power to each component included in the electronic device 100. The power supply unit 190 includes a battery, and the battery may be an embedded battery or a replaceable battery.

At least some of the components may operate cooperatively to implement the operation, control, or control method of an electronic device according to the various embodiments described below. Furthermore, the operation, control, or control method of the electronic device may be implemented on the electronic device by executing at least one application program stored in the memory 170.

In this specification, the electronic device 100 may be collectively referred to as a server, and the server may include a cloud server. Furthermore, the terminal may include all or part of the electronic device 100 and may include a tablet PC.

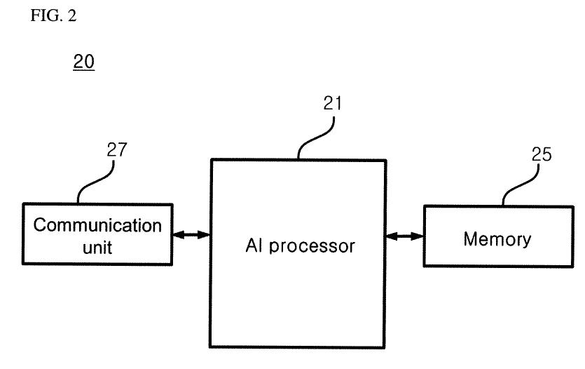

FIG. 2 is a block diagram of an AI device according to an embodiment of this specification.

The AI device 20 may include an electronic device including an AI module capable of performing AI processing, or a terminal including the AI module. Furthermore, the AI device 20 may be included as part of at least a portion of the electronic device 100 illustrated in FIG. 1 and configured to perform at least a portion of the AI processing.

The AI device 20 may include an AI processor 21, memory 25, and/or a communication unit 27.

The AI device 20, which is a computing device capable of learning a neural network, may be implemented in various electronic devices, such as a terminal, desktop PC, laptop PC, or tablet PC.

The AI processor 21 may learn a neural network using a program stored in the memory 25. For example, the AI processor 21 may perform the learning and inference functions of a machine learning model for learning and classifying log data. More specifically, the AI processor 21 takes the main features of the log (e.g., extension, execution path, location of ransom note, number of accessed files, etc.) as input values and calculates a similarity ratio for various program types (e.g., ransomware, cleaner, legitimate program, etc.), and this can serve as a key basis for determining true/false positives. To this end, the AI processor 21 may train a classification model based on supervised learning or inverse reinforcement learning by utilizing the learning algorithm and training data stored in the memory 25, and may classify logs in real time using the trained model.

Meanwhile, the AI processor 21, which performs the functions described above, may be a general-purpose processor (e.g., a CPU), but it may also be a dedicated AI processor for AI learning (e.g., a GPU, graphics processing unit).

The memory 25 may store various programs and data required for the operation of the AI device 20. The memory 25 may be implemented as non-volatile memory, volatile memory, flash memory, a hard disk drive (HDD), or a solid-state drive (SDD). The memory 25 is accessed by the AI processor 21, and data may be read/written/modified/deleted/updated by the AI processor 21. Furthermore, the memory 25 may store a neural network model (e.g., a deep learning model) generated through a learning algorithm for data classification/recognition according to one embodiment of the present disclosure.

Meanwhile, the AI processor 21 may include a data learning unit that trains a neural network for data classification/recognition. For example, the data learning unit may acquire learning data to be used for learning and train the deep learning model by applying the acquired learning data to the deep learning model.

The communication unit 27 may transmit the AI processing results generated by the AI processor 21 to an external electronic device.

Here, the external electronic device may include another terminal and/or a server.

Meanwhile, although the AI device 20 illustrated in FIG. 2 is functionally divided into an AI processor 21, memory 25, and communication unit 27, the aforementioned components may be integrated into a single module, referred to as an AI module or artificial intelligence (AI) model.

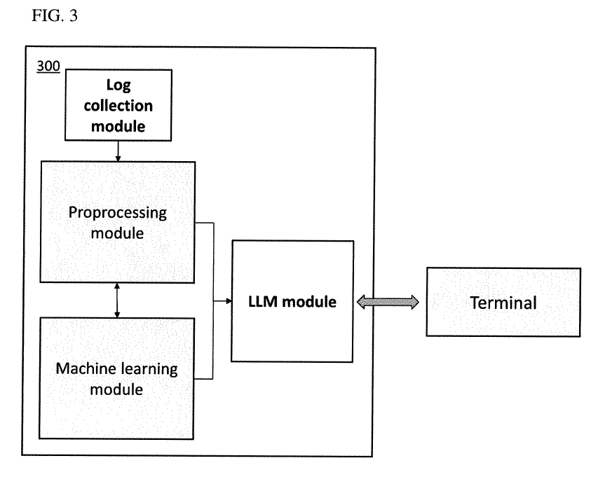

FIG. 3 illustrates a system for determining true/false positives and automatically interpreting a detected log based on machine learning to which this specification is applicable.

Referring to FIG. 3, the system 300 for determining true/false positives and automatically interpreting a detected log based on machine learning in this specification may be implemented as a physical server or a cloud server and may include a log collection module, a preprocessing module, a machine learning module, and an LLM module.

The log collection module may collect logs related to various security events occurring in a terminal, a server, network equipment, etc. For example, system logs, file access records, process creation and termination records, registry changes, etc., generated at the operating system level, are collected in real-time or at regular intervals, and these logs may be used as basic data for future detection and analysis. In addition, functions to filter unnecessary events that occur during log collection or to specify the scope of collection according to user settings may be provided. The logs are normalized into a consistent format or encrypted immediately upon collection and securely transmitted to the preprocessing module, and may include the collection time and device identification information to enhance the reliability of future tracking and analysis.

The preprocessing module may process log data received from the log collection module into a format suitable for machine learning analysis. For example, the preprocessing module may extract key features from logs, remove meaningless items, and convert them into a structured format. More specifically, the preprocessing module may separate fields such as filenames, file extensions, execution paths, the behavior time, and whether the service is registered, and convert them into vectors or text to use as model inputs. Additionally, preprocessing tasks may be performed, such as assigning weights to specific features based on past true/false positive cases, calculating scores by extension, and determining risk scores based on log length and components.

The machine learning module performs the function of classifying whether a log is a malicious detection (true positive) or a normal behavior (false positive) based on the preprocessed log data. This module utilizes algorithms based on supervised learning and inverse reinforcement learning to learn and can calculate similarity values by program type by analyzing various features such as file extensions, behavioral patterns, and system registration status.

For example, the machine learning module may generate a classification model by learning historical detection logs and true/false positive label data through supervised learning-based algorithms. If a specific file has features such as having the extension .Ex88824, being introduced through the Chrome browser, having a ransom note in the form of "ReadMe.txt" created in the Documents directory, and accessing 26 files and 3 directories, the preprocessing module may preprocess these features into an input vector and input them into the machine learning module, and the machine learning module may calculate similarity by program type, such as "Ransomware Type 001: 34.25%", "Cleaner Program: 13.27%", "Normal Program: 7.35%", etc.

Furthermore, the machine learning module utilizes Inverse Reinforcement Learning algorithms in parallel to incorporate experts' past judgment patterns into the model. That is, the system collects action policies (trajectories) regarding which judgments (true positives or false positives) security experts have made on specific logs in the past, and based on this, it is possible to estimate the reward function that experts have implicitly followed. For example, if an expert has repeatedly judged logs meeting conditions such as "file extension change + ransom note creation + access to multiple files" as true positives, the machine learning module may learn, through Inverse Reinforcement Learning, a structure in which high rewards are given for this combination of conditions. Through this, the model enables policy-based classification that reflects the expert's intuition even when labels are unclear or inconsistent, and may serve to complement or strengthen judgment results based on supervised learning.

Through the combination of these two algorithms, the machine learning module may provide an advanced classification model that goes beyond simple statistical classification and incorporates the practical judgment criteria of actual security analysts.

More specifically, the machine learning module may improve true/false positive classification performance by combining a supervised learning-based classification model and an inverse reinforcement learning-based policy model in an ensemble form. In this case, the core data used as a common input for both models may be a behavior graph generated by the preprocessing module. The preprocessing module constructs a node-edge-based behavior graph by analyzing the temporal and causal flow between events within the logs, and this graph may be utilized as data that structurally reflects high-risk behavioral patterns, such as sequences suspected of being the true positive (e.g., "ransom note creation → registration for auto-execution → access to multiple files").

Supervised learning models learn the probabilistic relationships between features and classes based on historically labeled true/false positive data, and may improve classification accuracy by including structural features extracted from the behavior graph (e.g., sequence embeddings, node centrality, repetitive actions, etc.). At the same time, inverse reinforcement learning-based models back-estimate the reward function based on the history of expert judgments and automatically generate policies similar to expert judgments when the same behavior flow is repeated. The results of the two models may be integrated through ensemble techniques (e.g., weighted average, soft voting) to produce a final true/false positive judgment result.

This configuration may provide the following technical benefits compared to a single model.

First, while supervised learning models provide prediction accuracy based on statistical boundaries, inverse reinforcement learning models may reflect the intuitive judgment criteria of experts even in environments with incomplete labels; therefore, through the complementarity of the two algorithms, the accuracy, reliability, and recall of true/false detection classification can all be improved. In particular, even when prediction results are inconsistent or uncertainty is high, the ensemble structure provides automatically adjusted judgments, thereby ensuring judgment stability for boundary cases.

Furthermore, by utilizing the behavior graph as a common input for both models, it becomes possible to make judgments that reflect complex behavioral sequences that are difficult to detect using only simple static features. For example, even logs classified as normal based on static information may be identified as high-risk sequences, such as “process injection → privilege escalation → ransom note creation,” through the behavior graph; this can contribute to reducing false negatives. Consequently, the machine learning module may provide the technical advantage of simultaneously achieving explainable detection based on expert judgment and high-speed automated judgment in large-scale log environments.

The LLM module receives program-type similarity results generated by the machine learning module and preprocessed log data from the preprocessing module as input, and outputs the reasons for the judgment and countermeasures as interpretation messages in natural language. For example, the LLM module may be implemented using large language models such as GPT, Claude, LLaMA, and Deepseek. Based on input data, the LLM module may automatically generate natural language-based interpretation messages, such as“the file contains numerous behaviors similar to ransomware and has a high similarity (N%) to Ransomware Type 001, so isolation measures are recommended,” and deliver them to the user via the terminal. In addition, if the similarity falls below a certain threshold, it may provide flexible explanations such as “Low security risk but user verification required” or “Possibility of false positives based on comparison with past similar logs.” Through this, a user environment can be provided where the basis for judgment and response measures can be intuitively understood and processed without the need for experts to directly interpret the logs.

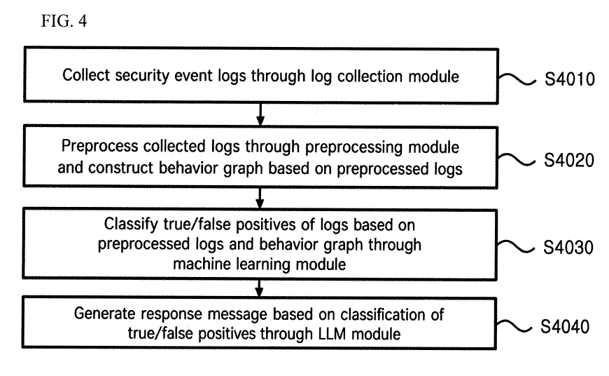

FIG. 4 illustrates a method for determining true/false positives and automatically interpreting a log to which this specification is applicable.

Referring to FIG. 4, the system 300 may perform true/false positive determination and automatic interpretation of logs using a log collection module, a preprocessing module, a machine learning module, and an LLM module.

Security event logs are collected through the log collection module S4010.

The system 300 may collect various security event logs through the log collection module. For example, logs are collected from various sources such as user terminals, network equipment, and servers, and may include all major security events occurring from executable files, process creation, file access, registry manipulation, network connections, etc. Collection may be performed in real-time or at regular intervals, and the log collection method may be implemented in various ways, such as OS API hooking, kernel monitoring, and agent-based collection. The logs collected likewise consist of multiple events; among these, meaningless events are filtered out, and important events may be stored along with meta-information such as identifiers (ID), timestamps, and paths. Additionally, the log undergoes a normalization process to ensure consistency of format, and then is encrypted and may be transmitted to another module within the system 300.

The preprocessing module preprocesses the collected logs and constructs a behavior graph based on the preprocessed logs S4020.

The preprocessing module may convert security logs transmitted from the log collection module into a format suitable for machine learning analysis. To this end, it extracts key features from the logs, such as filenames, extensions, process paths, the number of access targets, execution times, and whether the execution was automatic, and performs operations such as deduplication, field normalization, and vectorization. This may also include assigning weights by extension or calculating risk scores based on past true/false positive data.

In addition, the preprocessing module may construct a behavior graph based on the preprocessed logs. The preprocessing module analyzes the causal relationships between collected events and connects them in the form of nodes and edges to construct a graph enabling visual and structural analysis. For example, if a single process encrypts multiple files, creates a ransom note at a specific location, and registers an auto-execution key, this series of actions may be organized into a behavior graph in the order of “execution → access → creation → registration.”

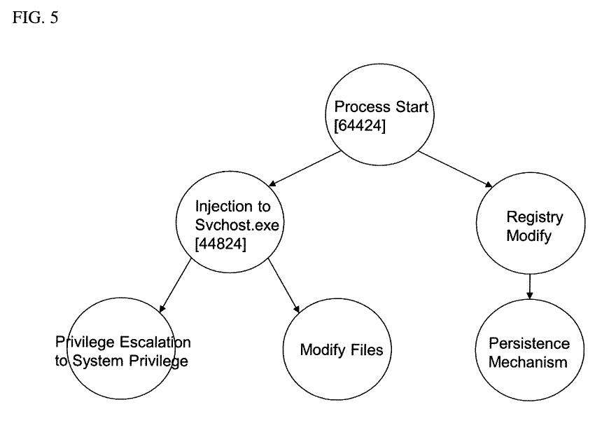

FIG. 5 illustrates a behavior graph to which this specification is applicable.

Referring to FIG. 5, the behavior graph represents the flow of actions performed by the target program after execution in a node-edge structure, which may serve as a key criterion for determining whether the actions are malicious. First, "Process Start " signifies the execution of a suspicious process, after which the process performs the "Injection to Svchost.exe " operation. This involves the injection of code into svchost.exe, a legitimate system process, and may correspond to a high-risk indicator commonly used in behavior-based detection.

Next, it can be confirmed that the process subsequently performs a series of malicious actions, such as "Privilege Escalation to System Privilege," "Modify Files," "Registry Modify," and "Persistence Mechanism." This consists of major attack vectors such as privilege escalation, file tampering, and auto-execution registration; this consistent flow resembles the typical patterns of general ransomware or Advanced Persistent Threat (APT) attacks. The preprocessing module extracts this behavioral flow as sequence-based features or transmits it to the machine learning module via graph embedding, and the LLM module may explain the basis for its judgment of true or false positives in natural language based on the corresponding behavior graph.

This behavior graph is converted into a sequence vector or graph embedding form so that it can be utilized as a feature in the machine learning module later. Furthermore, since this graph is also used as an input prompt for the LLM module when providing result interpretation to the user, the configuration of the behavioral flow during the preprocessing stage plays a doubly important role.

Referring again to FIG. 4, the machine learning module classifies true/false positives of the logs based on the preprocessed logs and behavior graph S4030.

The machine learning module receives the preprocessed logs and behavior graph data as input and may determine whether the logs are true positives (malicious) or false positives (normal). The machine learning module may be configured by merging algorithms based on supervised learning and inverse reinforcement learning. More specifically, supervised learning is learning classification boundaries from past labeled data (true/false positives), while inverse reinforcement learning is learning how security experts have judged in the past as action patterns and may model this as a reward function.

For example, if "RansomwareTestTool.exe," the source of the log, contains multiple malicious indicators such as the .Ex88824 extension, an unsigned state, the creation of a ransom note, and access to 26 files, the machine learning module may calculate a similarity distribution by category based on this information, such as "Ransomware Type 001: 34.25%", "Cleaner Program: 13.27%", "Normal Program: 7.35%".

Furthermore, behavior graph-based features enable the reflection of complex behavioral patterns that are difficult to detect using fixed rule-based methods. For example, the machine learning module may be trained so that sequential behavioral combinations, such as “ransom note creation → system auto-execution registration,” play a decisive role in determining true detection. Through this, the machine learning module may move beyond simply performing statistical classification based on independent static features and learn expert-level behavioral interpretation patterns that reflect the sequential relationships and causality between behaviors. In particular, high-risk sequences such as “ransom note creation → auto-execution registration” are combinations that security experts actually use as key grounds for determining malicious activity; by internalizing these complex behavioral structures into the machine learning module's model, more precise and practical detection judgments become possible.

Through the LLM module, a response message is generated based on the classification of true/false positives S4040.

The similarity results and behavior graph data derived from the machine learning module are passed to the Large Language Model (LLM) module, where the basis for judgment may be converted into a natural language message that humans can understand. The LLM module may be implemented using GPT, Claude, LLaMA, etc., and the input prompt may be configured in the form of “similarity result + preprocessing log + behavior sequence.”

For example, the LLM module may generate the following interpretation message:

“After execution, the file accessed multiple user document files, used the .Ex88824 extension, and created a ransom note in the form of ReadMe.txt in the Documents folder. This behavior is similar to the operation of past Ransomware Type 001 and is judged to be a true positive with a similarity of 34.25%. Isolation and removal are recommended.”

By intuitively explaining analysis results based on a behavioral flow, the LLM module enables reliable response decisions without requiring direct expert judgment. Furthermore, in cases of low similarity or ambiguous judgment, it enhances the system's flexibility and practicality by providing interpretations such as "Needs Review," "Pending," and "Candidate for Exception Handling."

Response messages may be delivered to the terminal, which may display them to the user in various forms, such as web dashboards, client apps, and email reports. These messages may include similarity distributions, interpretation messages, behavior graph summaries, and recommended response measures.

For example, users can check statuses such as "Isolated," "Under Review," or "False Positive" in real-time on the terminal screen and, if necessary, manually handle exceptions or request re-analysis. In this way, the terminal provides not only result viewing but also a user feedback route, which may be utilized as data to retrain the machine learning module's model.

Additionally, by providing behavior graph visualizations on the terminal, users may visually verify what actions the detected files performed. When provided along with interpretation messages, this serves to simultaneously enhance the transparency and persuasiveness of the judgment, and may significantly improve the speed and reliability of security incident response.

According to the present specification, the system 300 may dramatically improve the efficiency of analyzing large volumes of log data by fully automating a series of processes—such as automatically determining whether a detected security log is true or false and generating the basis for such determination—through a preprocessing module, a machine learning module, and an LLM module. Previously, manual analysis by humans became a bottleneck as the volume of logs increased; however, the system 300 may process the same volume of logs more quickly and stably through machine learning-based precise classification and natural language-based interpretation, thereby significantly reducing the time required for security analysis response.

Furthermore, moving away from the structure where experts manually decide on response measures after individually viewing and interpreting logs as in the existing method, it is possible to provide a structure in which a system automatically generates the judgment of true/false detection and response recommendations. This enables a significant level of judgment without human intervention; consequently, it allows for the maintenance or even improvement of analysis quality while minimizing the resources required by specialized personnel. In particular, by incorporating behavior graph-based analysis and In-Realm Learning (IRL), a clear technical differentiation from existing rule-based or static feature-based detection technologies can be ensured by enabling precise detection that incorporates expert-level judgment criteria.

The above-described specification may be implemented as a computer-readable code on a program-recorded medium. A computer-readable medium includes any type of recording device that stores data readable by a computer system. Examples of computer-readable media include hard disk drives (HDDs), solid-state disk drives (SSDs), silicon disk drives (SDDs), ROMs, RAMs, CD-ROMs, magnetic tapes, floppy disks, optical data storage devices, and even those implemented in the form of carrier waves (e.g., transmission through the Internet). Therefore, the above detailed description should not be construed as limiting in any respect and should be considered illustrative. The scope of this specification should be determined by a reasonable interpretation of the appended claims, and all modifications within the scope of equivalents of this specification are intended to be included within the scope of this specification.

Furthermore, while the above description focuses on services and embodiments, these are merely examples and are not intended to limit this specification, and those skilled in the art will appreciate that various modifications and applications not illustrated above are possible without departing from the essential features of the services and embodiments. For example, each component specifically described in the embodiments may be modified and implemented. In addition, the differences related to these modifications and applications should be construed as being included within the scope of this specification as defined in the appended claims.

What is claimed is:

1. A method for a system to perform true/false positive determination and automatic interpretation of a log, the method comprising:
collecting the log related to a security event through a log collection module;
preprocessing the log through a preprocessing module and constructing a behavior graph based on the preprocessed log;
classifying the true/false positives of the log based on the log and the behavior graph through a machine learning module; and
generating a corresponding message based on the classification of the true/false positives through a Large Language Model (LLM) module.

2. The method of claim 1, wherein the log comprises a system event log collected from a terminal, a server, or network equipment.

3. The method of claim 2, wherein the preprocessing module extracts, based on the log, a feature related to file extension, a path, an execution time, whether auto-run is registered, or the number of accessed files.

4. The method of claim 1, wherein the behavior graph is composed in a node-edge structure based on the causal relationship and chronological order between events, based on the log.

5. The method of claim 4, wherein the machine learning module learns a true/false positive classification model using pre-labeled log data based on a supervised learning algorithm.

6. The method of claim 5, wherein the machine learning module comprises an inverse reinforcement learning algorithm, estimates a reward function based on the past judgment history of a security expert, and models a policy based on the said reward function.

7. A system for performing true/false positive determination and automatic interpretation of a log, the system comprising:
a log collection module that collects the log related to a security event;
a preprocessing module that preprocesses the log and constructs a behavior graph based on the preprocessed log;
a machine learning module that classifies the true/false positives of the log based on the log and the behavior graph; and
a Large Language Model (LLM) module that generates a corresponding message based on the classification of the true/false positives.
